(19) United States
(12) Patent Application Publication
(10) Pub. No.: US 2024/0152616 A1
(43) Pub. Date: May 9, 2024

(54) DETECTION OF RANSOMWARE

(71) Applicant: THE COURT OF EDINBURGH NAPIER UNIVERSITY, Edinburgh (GB)

(72) Inventors: Bill BUCHANAN, Edinburgh (GB); Peter MCLAREN, Petersham (AU); Gordon RUSSELL, Edinburgh (GB); Zhiyuan TAN, Edinburgh (GB)

(73) Assignee: THE COURT OF EDINBURGH NAPIER UNIVERSITY, Edinburgh (GB)

(21) Appl. No.: 18/282,488

(22) PCT Filed: Mar. 8, 2022
(86) PCT No.: PCT/GB2022/050600

§ 371 Date: Sep. 15, 2023

(30) Foreign Application Priority Data
Mar. 18, 2021 (GB) 2103774.2

(51) Int. Cl. G06F 21/56; G06F 21/55

(52) U.S. Cl. CPC G06F 21/566; G06F 21/554

(57) ABSTRACT

The present invention relates to a computer program product, a computing device and a method of detecting a file encrypted by ransomware by identifying a file write operation for a file on the computing device and determining if a predetermined number of bytes of the file is stored in a memory buffer on the computing device. An entropy value of the predetermined number of bytes in the memory buffer is determined and compared to a first predetermined threshold, wherein if the determined entropy value exceeds the first predetermined threshold the file associated with the file write operation is flagged as being potentially encrypted by ransomware.

The present invention relates to the detection of ransomware and, in particular, to the detection of a file encrypted by ransomware on a computing device.

### BACKGROUND

Reliance on computing devices by users, such as home users, public services, governments, businesses, financial institutions, and so on, to perform multiple tasks and services have unfortunately led to a significant rise in malware attacks. Malware is typically a term used to refer to any malicious software that is designed to attack or damage computing devices, such as a server, computer, laptop, tablet, smart device, and so on. Malware typically covers a broad range of malicious software including, for example, a virus, Trojan horses, rootkits, spyware, ransomware, scareware, and so on.

Ransomware is a form of Malware that typically acts to encrypt data and files on the computing device and only providing the necessary encryption keys to decrypt the data and files on payment of a ransom. A ransomware attack may cause significant damage to the user's ability to function as well as to the user's reputation where the user is a business, government, public service, etc. As the users heavily rely on their data and files to function then a user may be willing to pay the ransom in order to obtain access to the data and files that have been encrypted by the ransomware. If the user does not pay the demanded ransom then the user runs the risk of permanently losing their data and files, or an expensive and time-consuming process to attempt to decrypt their data and files subsequent to the ransomware attack. As user's often pay the ransom demand then ransomware can become a lucrative business for the perpetrators of the ransomware meaning that the frequency and complexity of the ransomware attacks may increase.

Accordingly, there is a need to be able to detect ransomware before a user's data and files are completely encrypted in order to prevent the user's data and files being encrypted and the user being subject to a ransom demand. Thus, the present invention seeks to address, at least in part, the above described disadvantages and problems.

### STATEMENT OF INVENTION

According to a first aspect of the present invention there is provided a method of detecting a file encrypted by ransomware in a computing device, comprising: identifying a file write operation for a file on the computing device; determining if a predetermined number of bytes of the file is stored in a memory buffer on the computing device; determining an entropy value of the predetermined number of bytes in the memory buffer; comparing the determined entropy value of the predetermined number of bytes to a first predetermined threshold; and wherein if the determined entropy value exceeds the first predetermined threshold, flagging the file associated with the file write operation as potentially encrypted by ransomware.

The method may further comprise monitoring an operation of the computing device to identify the file write operation.

Determining the entropy value may be based on a Shannon entropy or a modified Shannon entropy.

If the determined entropy value does not exceed the first predetermined threshold, the method may further comprise comparing the determined entropy value to a second predetermined threshold, wherein the second predetermined threshold is lower than the first predetermined threshold.

If the determined entropy value exceeds the second predetermined threshold, the method may further comprise determining one or more parameters related to the predetermined number of bytes; comparing the determined one or more parameters to respective predetermined thresholds; and wherein if the determined one or more parameters do not exceed the respective predetermined threshold, flagging the file associated with the file write operation as potentially encrypted by ransomware.

The one or more parameters may include an ASCII frequency count and a maximum ASCII string length.

According to a second aspect of the present invention there is provided a computing device comprising: a processor; and a memory buffer; wherein the processor is configured to: identify a file write operation for a file on the computing device; determine if a predetermined number of bytes of the file is stored in the memory buffer on the computing device; determine an entropy value of the predetermined number of bytes in the memory buffer; compare the determined entropy value of the predetermined number of bytes to a first predetermined threshold; and wherein if the determined entropy value exceeds the first predetermined threshold, the processor is further configured to flag the file associated with the file write operation as potentially encrypted by ransomware.

The processor may be further configured to monitor an operation of the computing device to identify the file write operation.

The processor may be configured to determine the entropy value based on a Shannon entropy or a modified Shannon entropy.

If the determined entropy value does not exceed the first predetermined threshold, the processor may be further configured to compare the determined entropy value to a second predetermined threshold, wherein the second predetermined threshold is lower than the first predetermined threshold.

If the determined entropy value exceeds the second predetermined threshold, the processor may be further configured to determine one or more parameters related to the predetermined number of bytes; compare the determined one or more parameters to respective predetermined thresholds; and wherein if the determined one or more parameters do not exceed the respective predetermined threshold, the processor may be further configured to flag the file associated with the file write operation as potentially encrypted by ransomware.

The one or more parameters may include an ASCII frequency count and a maximum ASCII string length.

According to a third aspect of the present invention there is provided a computer program product comprising computer readable executable code for implementing any or all of the method features described herein.

### DRAWINGS

Embodiments of the invention will now be described, by way of example only, and with reference to the following drawings, in which:

FIG. 1 shows an activity flow according to one or more embodiments of the present invention.

FIG. 2 shows a flow chart for detection analysis according to one or more embodiments of the present invention.

FIG. 3 shows a flow chart for memory extraction according to one or more embodiments of the present invention.

FIG. 4 shows a flow chart for memory analysis according to one or more embodiments of the present invention.

FIG. 5 shows a flow chart for memory analysis according to one or more embodiments of the present invention.

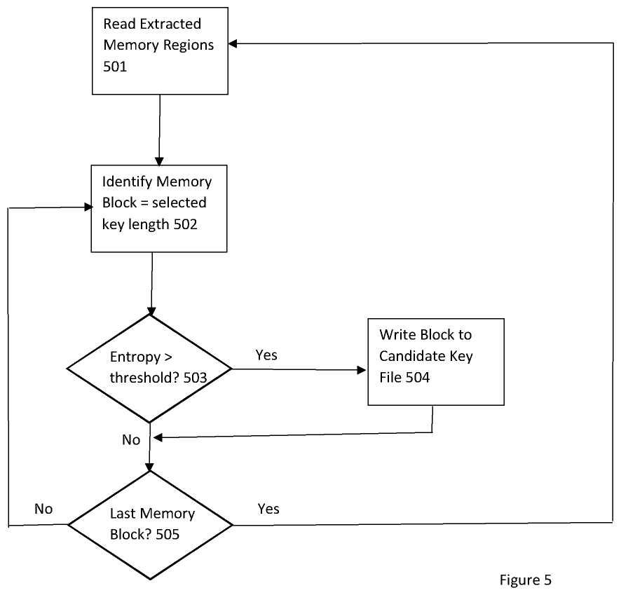

FIG. 6 shows a flow chart for decryption analysis according to one or more embodiments of the present invention.

FIG. 7 shows a flow chart for decryption analysis according to one or more embodiments of the present invention.

FIG. 8 shows a flow chart for decryption validation and verification according to one or more embodiments of the present invention.

### DETAILED DESCRIPTION

Cryptography has typically been used to protect the privacy of data from unauthorised access by third parties. The data is typically encrypted by converting the data plaintext into a ciphertext and subsequently decrypted by converting the ciphertext back into the data plaintext. In order to encrypt data there are two main concepts being symmetric key encryption and asymmetric encryption (also commonly known as public key encryption).

In asymmetric encryption a public key is used for encryption whilst a private key is used for the decryption of the data where the public and private keys are typically mathematically related to each other. Asymmetric algorithms attain security through computational complexity, which takes processor time, making them considerably less efficient than symmetric algorithms.

In symmetric encryption the same single encryption key is used for both the encryption and the decryption of the data.

Both symmetric key encryption and asymmetric encryption, or a combination thereof, may be used in ransomware attacks. Traditionally, symmetric key encryption is used in ransomware as the encryption/decryption process is considerably faster than asymmetric encryption but more modern ransomware may use a combination of asymmetric encryption and symmetric key encryption, for example, the asymmetric encryption may be used to encrypt the single symmetric key.

In symmetric key encryption, the algorithm used is often well-defined, and is known by all parties. The single encryption key is typically a randomly generated encryption key and common encryption key sizes for symmetric encryption are 128 bits or 256 bits, although other variants on the size of the encryption key could be used. Generally, the larger the encryption key size the more difficult it will be to determine the randomly generated encryption key by an unauthorised party, for example, if there are n bits in the encryption key, the number of possible encryption keys will be 2ⁿ and the average number of keys to search for will be 2ⁿ⁻¹. Presently, it is not computationally efficient to discover a randomly generated encryption key which is greater than or equal to 128 bits due to the sheer computing power and/or time required to discover the randomly generated encryption key.

Symmetric key encryption algorithms are typically either stream encryption, where the encryption process of the data works on one bit at a time, or block encryption, where the encryption process of the data works on blocks of bytes.

As the same encryption key is used for both encryption and decryption in symmetric key encryption algorithms then there is a risk that sections of data (e.g. plaintext) that are identical would be encrypted to the same ciphertext, thereby potentially making it is possible to see patterns of data within the ciphertext. In order to prevent this, an initialisation vector (IV) is typically used to provide a notion of randomness to the encryption process to ensure that identical sections of data do not result in an identical encrypted ciphertext. The IV is commonly referred to as a nonce where the nonce typically has a predetermined bit length. By using a different nonce for each encryption process, e.g. for each block of an encrypted file, then whenever the same data (e.g. plaintext) is encrypted into ciphertext a different pattern of ciphertext is obtained. When substantial amounts of data or files are encrypted, the nonce value for each encryption, after the initial nonce is randomly generated, is typically derived from the previous encryption or contains an incremented sequence number.

During a ransomware attack, the data on a computing device is encrypted and a ransom is demanded in order for the data to be restored. In embodiments of the invention, the ransomware attack can be detected whilst it is occurring, that is while the ransomware is actively operating on the computing device, and prior to the complete encryption of a user's data on the computing device. In some embodiments, once the ransomware attack has been detected then further steps may be taken in relation to the extraction of the relevant memory, analysis of the memory extracted and decryption analysis to restore the user's original data.

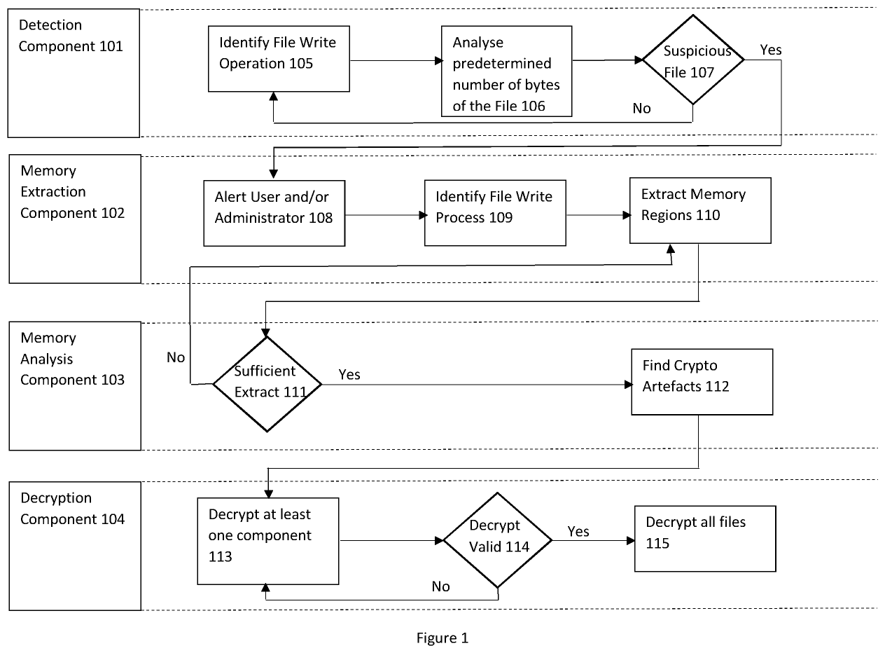

The overall activity flow according to one or more embodiments of the invention is shown in FIG. 1. The process may include four main components, a Ransomware Detection component 101, a Memory Extraction component 102, a Memory Analysis component 103, and a Decrypt Analysis component 104. The Ransomware Detection component 101 starts by identifying a file write operation 105, then at least one component of the file being written is analysed 106, and it is determined if the file write operation potentially relates to a ransomware attack 107. If it is not determined that the file write operation potentially relates to a ransomware attack then the activity flow returns to wait to identify a further file write operation. However, if the file write operation is determined to potentially relate to a ransomware attack the activity flow proceeds to the Memory Extraction component 102 and an alert may be sent to a user of the computing device and/or to an administrator of the computing device 108.

The Memory Extraction component 102 may then identify the file write process 109 and extract at least one section of memory 110 relating to encryption and the identified file write process.

The activity flow then proceeds to the Memory Analysis component 103 which may identify if a sufficient amount of memory extracts are obtained 111 and, if so, identifies one or more potential crypto artefacts from the at least one extracted section of memory 112.

Once the potential crypto artefacts have been identified the activity flow proceeds to the Decrypt Analysis component 104 to decrypt at least one component of the potentially encrypted file 113 and determine if a valid decryption has occurred 114. If a valid decryption has occurred then the file is decrypted 115 and the activity flow ends. If it is determined that a valid decryption has not occurred then the Decrypt Analysis component 104 will further attempt to decrypt at least one component of the potentially encrypted file 113 using further identified potential crypto artefacts.

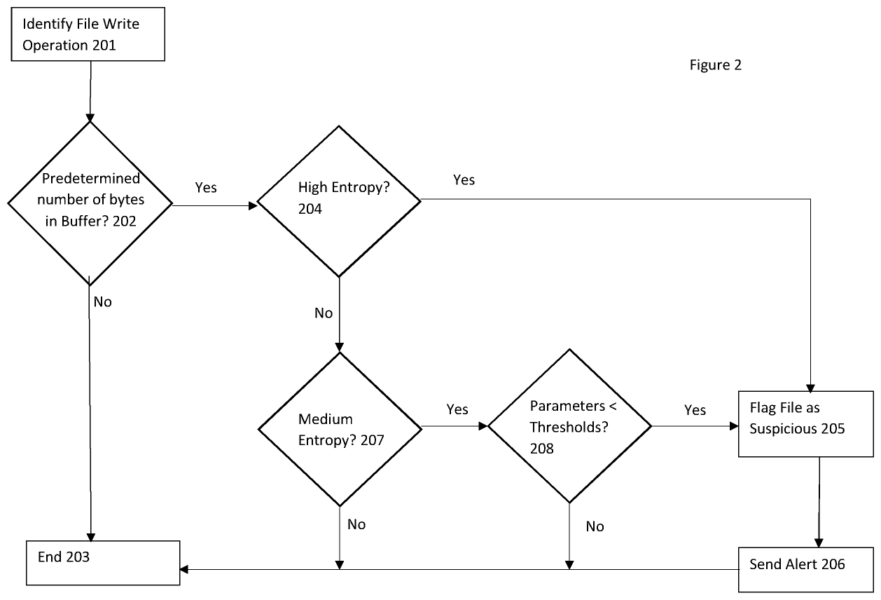

The detection of the ransomware attack will now be described with reference to FIG. 2. The ransomware detection component monitors a file system on a computing device to detect malicious activity which may be caused by ransomware executing on the computing device.

The file system of a computing device is typically a collection of files stored on non-volatile memory such as magnetic disks and/or optical disks. The files are typically a sequence of bits or bytes of data that can relate to information for a user, information for a program/application on the computing device, output from a program/application on the computing device, executable files, object files, text files, and so on. Typically each file has a predetermined structure to enable applications executing on computing devices to access the file contents. The file structure commonly comprises a file header followed by a file body or simply plaintext if it is a text file.

The size of the file header may be dependent on the type of file. Thus, the file header will typically contain non-random data such as ASCII alphanumeric character strings, printable characters and null bytes as a significant proportion, or as a high percentage, of the file header.

As a legitimate file typically contains at least a substantial proportion of non-random data then the legitimate file (i.e. not encrypted by ransomware) will commonly have a low entropy. Entropy is a measure of randomness of data where data with high entropy is completely random whilst data with low entropy is less random. Several well-known methods can be used to measure the entropy of data, such as Shannon entropy, Renyi entropy, guessing entropy, min-entropy, differential entropy, relative entropy, and so. In the embodiments described, Shannon entropy will be used as it provides an efficient mechanism for the measurement of random data. Ransomware encrypted files will typically have a higher Shannon entropy measurement than unencrypted files. Shannon entropy is defined as:

$$H = - {\sum }_{i = 1}^{n} p ( i ) {log}_{2} p ( i ) . \qquad Equation 1$$

Where H is the normalised Shannon entropy, n is the number of bytes, and p(i) is the probability of the byte i occurring. However, the calculation of the Shannon entropy using Equation 1 requires the use of both division and logarithm mathematical operations which are commonly calculated with floating point processors in the computing device, where frequent use of the floating point processor at operating system kernel level is often disruptive for normal computing device operation. Therefore, for performance reasons a modified Shannon entropy equation is used and is defined as:

$${H}_{mod} = {\sum }_{i = 1}^{255} {d}_{i} [ {f}_{i} ] . \qquad Equation 2$$

where H_{mod} is the Shannon entropy raised to a predetermined power, fᵢ is the count of occurrences of character i in a string of n bytes, and delta values dᵢ are previously calculated or predetermined. The predetermined power may be any suitable value, e.g. 10³, 10⁴, 10⁵, 10⁶, 10⁷, 10⁸, 10⁹, and so on, where the selection of the predetermined power may be dependent on, for example, the level of accuracy required where a higher power increases the accuracy. The delta values represent the frequency of occurrence of character i in the string multiplied by the predetermined power so as to avoid the use of floating point processors.

For example, to obtain a modified Shannon entropy to the power of 10⁷ for a string of length 16, that is n=16, the delta values dᵢ can be predetermined as {2500000, 3750000, 4528195, 5000000, 5243974, 5306390, 5217822, 5000000, 4669171, 4237949, 3716407, 3112781, 2433927, 1685644, 872900, 0}. The modified entropy H_{mod} is a close approximation of the Shannon entropy H raised to the predetermined power.

Returning to FIG. 2, the detection method of the detection component monitors for and/or identifies file write operations to the storage medium occurring in the computing device 201. Typically, in order to make the performance of the computing device more efficient, when a file is written to a storage medium, such as a hard drive magnetic disk, the file data is buffered in a temporary memory, such as a Random Access Memory (RAM) device, and then subsequently written to the storage medium. The detection component can monitor for, and/or identify, a file write operation 201 and determine whether a predetermined number of bytes of the file is stored in the buffer 202. The predetermined number of bytes may be any suitable number of bytes, for example, 8 bytes, 16 bytes, 32 bytes, 64 bytes, 128 bytes and so on. As the file being written may contain a file header or plaintext then by determining whether a predetermined number of bytes is stored in the buffer advantageously enables the detection of an encrypted file that may, or may not, include a file header. In the following examples and embodiments, the predetermined number of bytes is 64 bytes as it is expected that an encrypted file will contain at least 128 bytes due to the additional bytes added by ransomware to a file.

If it is determined that the predetermined number of bytes is not stored in the buffer then the current detection method ends 203.

If the detection component determines that the predetermined number of bytes of the file, e.g. the initial 64 bytes of the file, is in the buffer then the detection component proceeds to analyse the 64 bytes associated with the file write operation. The detection component analysis of the 64 bytes may initially include determining an entropy value of the 64 bytes, for example, based on the modified Shannon entropy or the Shannon entropy described hereinabove. The determined entropy value of the 64 bytes may then be compared to a first predetermined entropy threshold value to determine if the file header has a high entropy 204.

The first predetermined entropy threshold may be any threshold suitable for determining whether the 64 bytes has a high entropy and relevant for the method used to determine the entropy value. For example, if a modified Shannon entropy value is determined, using a predetermined power of 10⁷, then the first predetermined threshold may be 55000000, whilst if a Shannon entropy value is determined the first predetermined threshold may be 5.5. If the determined entropy value exceeds the first predetermined entropy threshold value such that the initial 64 bytes of the file stored in the buffer has a high entropy 204 then the file associated with the write operation is flagged as suspicious, or potentially encrypted by ransomware, 205, e.g. flag the file associated with the file write operation as being potentially encrypted by ransomware to identify a potential ransomware attack on the computing device. Subsequently, an alert notification may be provided to the user and/or administrator of the computing device 206. The detection method may then end 203. A flagged file write operation may then be further analysed as will be described further below.

If the determined entropy value does not exceed the first predetermined entropy threshold, e.g. the initial 64 bytes of the file stored in the buffer does not have a high entropy, 204 then the detection method of the detection component may end.

However, the 64 bytes with a determined entropy that does not exceed the first predetermined threshold may still be suspicious and potentially a file being encrypted by ransomware. Therefore, to make the detection method more robust a second threshold value may be predetermined where the second predetermined threshold is lower than the first predetermined threshold in order to determine if the file header has a medium entropy. For example, the second predetermined threshold may be 50000000 for an entropy value determined using the modified Shannon entropy, with a predetermined power of 10⁷, and 5.0 for an entropy value determined using the Shannon entropy. As will be appreciated, the second predetermined threshold may be any suitable threshold and relevant to the method used to determine the entropy value.

If the determined entropy value of the file header in the buffer exceeds the second predetermined threshold but is lower than the first predetermined threshold, e.g. has a medium entropy, 207 then the detection method may further analyse the 64 bytes in order to determine one or more parameters relating to the 64 bytes. For example, the detection component may determine as the one or more parameters, one or more of an ASCII frequency count and a maximum ASCII string length. As will be appreciated, other parameters may be alternatively or additionally determined, for example, a null byte frequency, or to identify whether typical file header strings are present, for example, “PDF”, “MZ, “JIFF”, in particular in the first 2 to 10 bytes of the initial 64 bytes of the file stored in the buffer.

The ASCII frequency count is the number of occurrences of the printable ASCII alphanumeric characters. This is because an unencrypted file header would be expected to contain a higher frequency of printable ASCII alphanumeric characters whilst an encrypted file would be expected to contain a lower frequency of printable alphanumeric characters.

The maximum ASCII string length is the longest printable ASCII string in the 64 bytes. In an unencrypted file the typical maximum ASCII string length would typically be greater than 3, whilst in an encrypted file it would be expected that the maximum ASCII string length would be lower than for an unencrypted file header, thus for an encrypted file the maximum printable ASCII string length would typically be fewer than 3.

The detection component may determine one or both of the ASCII frequency count and the maximum ASCII string length of the 64 bytes. The determined metrics may then be compared to respective predetermined thresholds, for example:
(ascₕ<asc_{T}) and/or (maxstrₕ<maxst_{T})
   where asc is the printable ASCII frequency count of the 64 bytes and maxstr is the maximum printable ASCII string length of the file header. The subscripts ₕ relate to the 64 bytes and _{T} relate to the respective predetermined threshold.

Therefore, if the determined entropy value of the initial 64 bytes of the buffer is lower than the first predetermined entropy threshold but exceeds the second predetermined entropy threshold and one or more of the above comparisons is true 208 then the file associated with the write operation is flagged as suspicious, or potentially encrypted by ransomware, 205, e.g. flag the file associated with the file write operation as being encrypted by ransomware to identify a potential ransomware attack on the computing device. Optionally an alert may be provided to the user and/or the administrator of the computing device 206. The detection method may then end 203. A flagged file write operation is then further analysed as will be described further below

If the determined entropy value of the 64 bytes does not exceed the second predetermined entropy threshold 207 then the detection method may end 203.

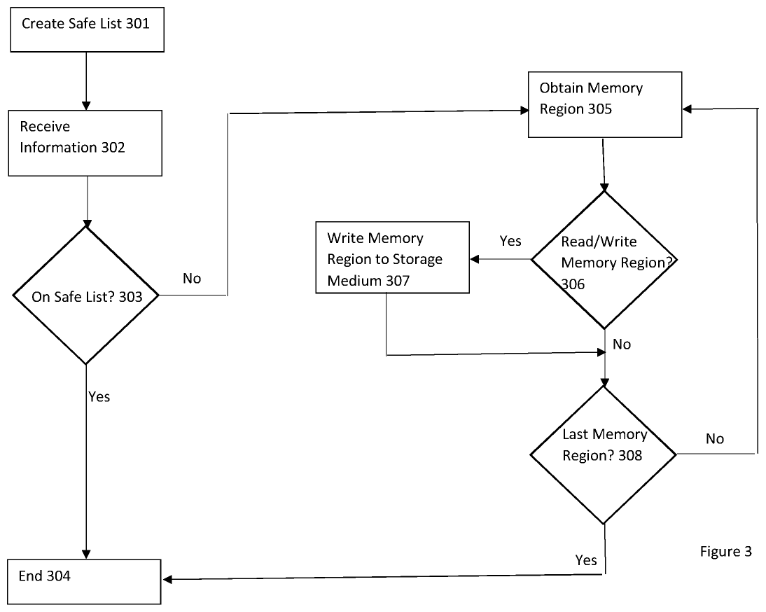

With reference to FIG. 3, the memory extraction component creates a safe list of file write operations 301, where the safe list may be created in advance and maintained as and when necessary, or the safe list may be created each time the memory extraction component executes. The safe list may be maintained and updated as required in order to provide a list of file write operations that are allowed, e.g. safe, and would not be considered as part of an active ransomware attack. When a file write operation is flagged as suspicious, or potentially encrypted by ransomware, by the Detection component information associated with the suspicious activity (e.g. the detected potential ransomware file write operation) is provided to the memory extraction component 302. The information provided may include one or more of the process name, the process identifier (PID), the filename of file being written, the determined entropy value, along with any other measurements or parameters determined by the Detection Component. The memory extraction component compares one or more of the information associated with the flagged file write operation to the maintained safe list 303. File write operations that are considered as being safe are, for example, the memory extraction component itself, an svchost.exe process on a Windows operating system, certain web browsers that may write high entropy data, and so on. As will be appreciated, there may be several operations and processes which are safe but include file write operations that may include high entropy data.

If the flagged file write operation is identified to be safe 303 based on one or more entries in the safe list then the method ends 304 and no further action is taken.

However, if the flagged file write operation is not on the maintained safe list 303 then the memory extract component identifies and extracts sections or regions of the memory that relate to the flagged file write operation. In order to improve performance and efficacy the sections of memory extracted are restricted to memory sections that may contain the requisite cryptographic artefacts (e.g. the nonce and the encryption key).

Once the complete file has been encrypted by the ransomware then the ability to potentially identify the cryptographic artefacts may be lost. However, whilst a file is being encrypted by the ransomware the cryptographic artefacts may exist in the volatile memory of the computing device and, therefore, the timely acquisition and extraction of the relevant sections of memory of the computing device infected by the ransomware provides a window of opportunity to discover and identify the cryptographic artefacts being used by the ransomware during the encryption process. The cryptographic artefacts are typically generated at the commencement of the encryption process by the ransomware and are retained in the read/write memory of the associated file write process for the duration of the encryption of the file by the ransomware.

The relevant sections of memory to be extracted can be identified based on an identification of the encryption process running in the computing device that are associated with the flagged file write operation. Performance is highly correlated with memory extract size and so by identifying the encryption process running that is associated with the flagged file write operation it restricts the size of the required memory extract which improves performance.

The memory used by the encryption process can be divided into read-only memory (containing, for example, executable instructions), and writable memory (containing, for example, data structures that are generated after the encryption process has commenced). Therefore, as cryptographic artefacts are commonly generated during the encryption of the file, the encrypting process typically stores the cryptographic artefacts in the writable memory. Furthermore, as the generated cryptographic artefacts are process data fields they will commonly be located in user-level, rather than kernel level, memory and so to further limit the extracted memory size only the user-level writable memory of the identified encryption process may be extracted. Any number of memory extracts may be performed by the memory extraction component, however, in order to limit the amount of memory extracted one or two separate memory extracts may be performed.

Returning to FIG. 3, the memory extraction component obtains a first memory region associated with the identified encryption process 305. It is then determined whether the first memory region is a read/write memory region 306. If the first memory region is a read/write memory region then the first memory region is extracted by writing the first memory region to a storage medium 307. It may then be determined if the memory region relating to the identified encryption process is the last memory region 308. If it is determined that it is not the last memory region then a further memory region is obtained 305 and the process repeated. If it is determined that it was the last memory region associated with the identified encryption process then the function of the memory extraction component ends.

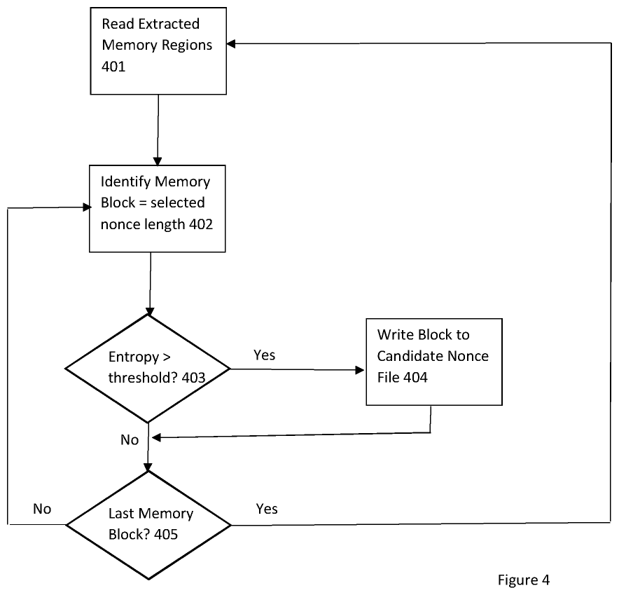

With reference to FIG. 4, the extracted memory is then available to a memory analysis component which searches the memory extracts for candidate cryptographic artefacts, e.g. the nonce and the encryption key. The memory extract may comprise the complete, or partial, file write buffer but as the cryptographic artefacts are typically stored in other memory locations the file write buffer may be excluded from the memory analysis to further improve the performance.

Whilst a file is being encrypted by ransomware, it typically appends to each encrypted file various parameters. The parameters may include, for example, checksum values, name of the file prior to encryption, file size prior to encryption, nonce and encryption key. Typically, the encryption key is encrypted using the ransomware private key but the nonce may often be unencrypted.

If the nonce is unencrypted the memory analysis component may also check or determine whether specific data at the end of the encrypted file is available in the memory extract.

The nonce may also have several typical characteristics, such as the nonce length and the nonce structure. A nonce length is dependent on the encryption algorithm employed by the ransomware but will typically be 8 bytes, 12 bytes or 16 bytes. The nonce structure may include a first set of bytes being a random string and a second set of bytes being a sequence number, for example, in a 16 byte nonce the first 12 bytes may be random and the remaining 4 bytes may be a number identifiable as a sequence number. This structure of the nonce is typically used to ensure that the same plaintext is encrypted differently by each encryption. The sequence number of the nonce may be an incremental number which is incremented after each encryption. A candidate nonce may therefore be identified as a highly random string or a highly random string followed by a sequence number which is of the expected length of a nonce, depending on the type of encryption used by the ransomware, e.g. the specific encryption algorithm.

The memory analysis component may first look to identify candidate nonce values before identifying candidate encryption keys in the extracted memory due to the typical characteristics of the nonce. Once candidate nonce values are identified then the location of the candidate nonce in memory may provide an indication in memory of the location of the encryption key used as both the nonce and encryption key are typically stored adjacent or proximal to each other in memory.

The memory analysis component searches the relevant extracted memory to initially look for candidate nonce values. The search is based on an expected size or length of the nonce value, (for example, 8, 12, 16 or 32 bytes) and initially starts with a selected first nonce length. The memory analysis component reads a file of the extracted memory regions 401 and identifies a first memory block that matches the length of the selected first nonce length 402. As mentioned above, the nonce will either be a highly random string or a highly random string followed by a sequential number. Therefore, as the nonce comprises at least partially a highly random sequence then the memory analysis component determines the entropy value of the first memory block and compares the entropy value with a predetermined first analysis threshold 403. The predetermined first analysis threshold may be any suitable threshold and may be dependent on the nonce length and the method used to determine the entropy value. For example, if the nonce length is 16 bytes and the Shannon entropy is used the threshold may be 3.8, or if the modified Shannon entropy is used with a predetermined power of 10⁷ the threshold may be 38000000.

If the entropy value of the first memory block exceeds the predetermined analysis threshold a candidate nonce is potentially identified and written to a candidate nonce file 404. Additional parameters relating to the candidate nonce may also be written to the candidate nonce file, for example, the memory location of the candidate nonce.

The memory analysis component then determines if the last memory block of the file of memory extracts has been reached 405. If the last memory block has not been reached a further memory block of the first selected nonce length is identified 402 and the process repeated. For example, a second memory block of the same length as the selected nonce is identified 402, the entropy value for the second memory block is compared to the predetermined first analysis threshold 403 and if the entropy value exceeds the predetermined threshold it is written to the candidate nonce file 404.

Each further memory block may be identified using a sliding window of a predetermined number of bytes. The predetermined number of bytes for the sliding window may be any suitable number of bytes, for example, 4 bytes. Alternatively, each further memory block may be identified as an adjacent memory block of the selected nonce length.

If the last memory block has been reached 405 then a further second nonce value length may be selected and the process is repeated, that is the extracted memory is read by the memory analysis component 401, a first memory block is identified where the memory block matches the selected second nonce value length 402, the entropy value of the first memory block is compared to the predetermined first analysis threshold 403, if the threshold is exceeded then a candidate nonce is written to a candidate nonce file 404, if the last memory block has not been reached 405 then a further memory block is identified 402, the entropy value of the further memory block is compared to the predetermined first analysis threshold 403, if the threshold is exceeded then a candidate nonce is written to a candidate nonce file 404, and so on for further memory blocks until the last memory block of the memory extract is reached 405.

Once the complete extracted memory has been examined for candidate nonce values of the selected second nonce value length, then the process may repeat for further selected nonce value lengths until all possible nonce value lengths have been used to analyse the extracted memory.

Once all possible nonce value lengths have been used to analyse the extracted memory one or more candidate nonces may be stored in the candidate nonce file. It is expected that the number of candidate nonces identified may be in the region of hundreds or thousands candidate nonces from the extracted memory.

In the above description each nonce value length is selected sequentially and the process of identifying candidate nonces is performed for each potential nonce value length until all potential nonce value lengths have been used to analyse the extracted memory.

However, as will be appreciated, alternatively once the extracted memory has been analysed using a selected nonce value length to obtain candidate nonces for that selected nonce value length, the process may move onto analysing the extracted memory for candidate encryption keys related to the obtained nonces. At that point the process may attempt to decrypt the potentially encrypted file with the candidate nonce and encryption key pairs before the process is iteratively repeated, that is analysing the extracted memory for further candidate nonces of a different nonce value length and related candidate encryption keys, should the particular decryption attempt be unsuccessful.

In a further alternative, once a candidate nonce has been obtained for the selected nonce length value the process may proceed to analyse the extracted memory for a candidate encryption key that is proximal to the candidate nonce and that pair of a candidate nonce and a candidate encryption key may be used to attempt to decrypt the potentially encrypted file prior to analysing the extracted memory for a further candidate nonce of the selected nonce value length and a further proximal candidate encryption key, should the decrypt attempt be unsuccessful.

The process may alternatively analyse the extracted memory for candidate nonces of a first selected length and then analyse the extracted memory for related candidate encryption keys before iteratively repeating the analysis of the extracted memory for candidate nonces of a further selected nonce value length and related candidate encryption keys until all possible nonce value lengths have been used and prior to attempting to decrypt the potentially encrypted file.

Thus, it will be appreciated that the order of analysing the extracted memory for candidate nonces and candidate encryption keys along with attempting to decrypt the potentially encrypted file can be performed in any suitable order.

As mentioned hereinabove, the nonce may comprise a first set of bytes being a random string and a second set of bytes being a sequence number, for example, in a 16 byte nonce the first 12 bytes may be random and the remaining 4 bytes may be a number identifiable as a sequence number. In this example, the candidate nonce may be based on the complete 16 byte nonce length, or may be based on the first 12 bytes, when determining the entropy and comparing to the predetermined threshold. Alternatively, the candidate nonce may be identified when the selected nonce length is 12 bytes and if a memory block of 12 bytes has an entropy that exceeds the threshold the memory analysis component may determine whether the following bytes, e.g. 4 bytes in this example, represent a low entropy value that is a sequence number, and combine both the 12 bytes and the following 4 bytes into a single candidate nonce which is written to the candidate nonce file.

Thus, a candidate nonce may be identified when a shortened nonce and a sequence number are used. Typically, the initial sequence number value is “0000” or “0001” so the presence of a random string followed by a sequence number in the extracted memory identifies a candidate nonce based on the determination that the following equation is true.

q≤1+n+e Equation 3.

where q is the sequence number in the extracted memory, n is the quantity of encrypted blocks, and e is the quantity of blocks appended by the ransomware.

The memory analysis component may then proceed to identify candidate encryption keys. The encryption keys are randomised byte sequences of a fixed length (depending upon the encryption algorithm used by the ransomware) that are typically constant for each encrypted file and may be stored in data structures in the memory with other cryptographic artefacts, such as the nonces. Therefore, memory blocks or segments in the extracted memory that are proximal to candidate nonce memory locations and are sufficiently random may be candidate encryption keys. The memory locations of the candidate nonces are stored in the candidate nonce file with the respective candidate nonce. Therefore, the memory analysis component may take into account the memory locations of the candidate nonces when analysing the extracted memory for candidate encryption keys and/or take into account the memory locations of identified candidate nonces when performing the decryption in order to identify suitable candidate nonce and encryption key pairs. The search may be based on an expected size or length of the encryption key, (e.g. 16, 24 or 32 bytes) and may initially start with a selected first encryption key length.

The memory analysis component may read the file of extracted memory regions 501 and identify a memory block of the first selected encryption key length 502. An entropy value for identified memory block is determined and compared to a predetermined second analysis threshold 503. The entropy value of the identified memory block may be determined using any suitable method, such as the Shannon or modified Shannon methods given in Equations 1 and 2 respectively. The predetermined second analysis threshold may be any suitable threshold based on the method used to determine the entropy value for the identified memory block and on the encryption key length. For a 256-bit encryption key and using the Shannon entropy then the threshold may be 4.65, or using the modified Shannon entropy, with a predetermined power of 10⁷, the threshold may be 46500000.

If the entropy value of the memory block exceeds the predetermined second analysis threshold the memory block is written to a candidate key file as a candidate encryption key 504. It is then determined if the last memory block of the file of extracted memory regions has been reached 505. If the last memory block has not been reached then a further memory block of the selected encryption key length is identified 502 and the process repeated.

If the last memory block of the extracted memory regions has been reached then a further encryption key length may be selected and the process repeated until all potential encryption key lengths have been selected and the extracted memory region file has been searched for all potential candidate encryption keys.

Once the extracted memory has been analysed by the memory analysis component with candidate nonce and candidate encryption keys written to the respective files then the memory analysis component process ends.

In the above described embodiments and examples, the memory analysis component first searched the extracted memory segments for candidate nonces and subsequently searched the extracted memory segments, based on the location of the candidate nonces, for candidate encryption keys. However, additionally, or alternatively, the memory analysis component may search for both candidate nonces and candidate encryption keys simultaneously, for example on computing devices with multiple processors. As mentioned above, a candidate nonce and corresponding candidate encryption key are typically stored proximal to each other, which may aid the identification of suitable candidate nonce and candidate encryption key pairs.

As an example, the memory analysis component may identify a candidate nonce, based on a 16-byte (128-bit) nonce length, in the extracted memory segment between memory locations 604C0 and 604CF:

604130: CD CD CD CD CD CD CD CD 30 7E AC 00 50 A2 AC 00
604CO: 33 A1 DB 46 51 9E 1D 25 D6 07 AF 95 B4 D8 31 E1
604D0 CD CD CD CD CD CD CD CD CD CD CD CD CD CD CD CD.

The memory analysis component may then identify a candidate encryption key, based on a 32-byte (256-bit) encryption key, in the extracted memory segment between 600F8 and 60117 (which is proximal to the candidate nonce):
600FO: 71 6D 21 00 FD FD FD FD 71 E9 FC D8 60 54 24 21
60100: 9D 83 97 CB D2 EF A8 A3 E7 B0 67 5F A4 27 97 77
60110: 55 OF 96 D6 D3 28 3B EC BF 8F C8 3B DF DB EC 1A.

Presently, there are several known encryption algorithms, such as the Advanced Encryption Standard (AES), ChaCha20, and Salsa20, wherein each encryption algorithm has certain typical characteristics.

For example, AES the nonce length is typically 16 bytes (128 bits) where the nonce may be a single random nonce or may be segmented into a shortened nonce (e.g. 12 bytes) and a sequence number (e.g. 4 bytes), and with a typical encryption key length of 16 bytes (128 bits), though AES may also support encryption key lengths of 24 bytes (192 bits) and 32 bytes (256 bits).

In ChaCha20 the nonce length is typically 8 bytes (64 bits), though variants may use a nonce of 24 bytes (192 bits), and the encryption key length is typically 16 bytes (128 bits). ChaCha20 also has the characteristic that it appends a specific ASCII data sequence alongside the nonce and encryption key. The ASCII data sequence is “expand 32-byte k” and therefore, the memory analysis component may additionally identify this ASCII data sequence in the extracted memory which will indicate that the encryption algorithm used is the ChaCha20 encryption algorithm.

In Salsa20, the ASCII data sequence of “expand 32-byte k” is also to generate the stream and therefore the memory analysis component may additionally identify this ASCII data sequence in the extracted memory which will indicate that the encryption algorithm used is the Salsa20 encryption algorithm. In Salsa20, the nonce length is typically 8 bytes (64 bits) and the encryption key is typically 32 bytes (256 bits).

Thus, the memory analysis component may search the extracted memory for all possible nonce lengths and all possible encryption key lengths in order to identify candidate nonces and candidate encryption keys related to one or more encryption algorithms.

Once the candidate nonces and candidate encryption keys have been identified a decryption analysis component uses the candidate nonces and candidate encryption keys to determine whether at least part of the encrypted file of the flagged file write operation can be decrypted. The decryption analysis component may further perform a verification check to determine that at least part of the file has been decrypted.

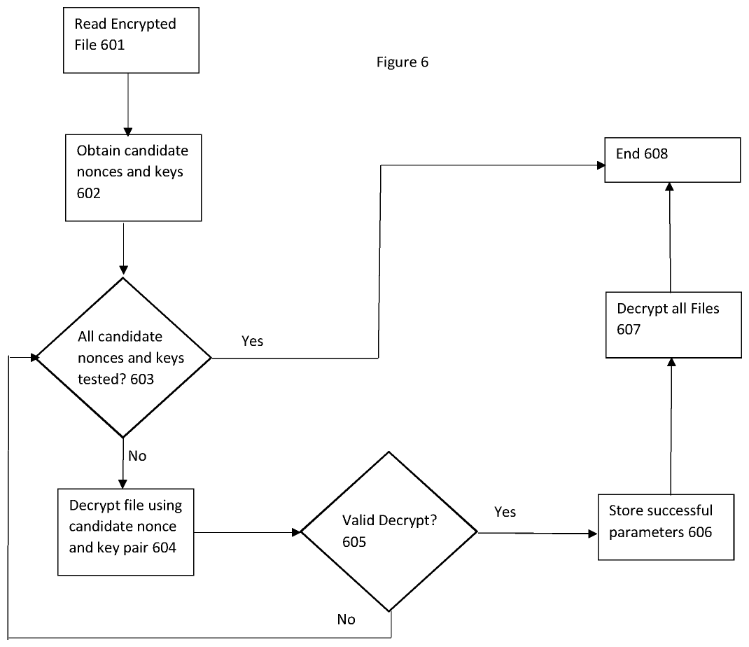

With reference to FIG. 6, the general decryption process implemented by the decryption analysis component starts by reading the encrypted file from memory, or from a storage medium 601. The candidate nonces and candidate encryption keys are obtained from the respective files 602. It is determined whether all pairs of the candidate nonces and candidate encryption keys have been tested 603. If not all of the possible candidate nonce and candidate encryption key pairs have been tested then the decryption analysis component attempts to decrypt at least part of the encrypted file using one candidate nonce and candidate encryption key pair and generate a first potential decrypted file 604. As mentioned above, all potential combinations of candidate nonce and candidate encryption key pairs may be tried and/or the candidate nonce and candidate encryption key pairs may be selected based on the proximal memory locations of the respective candidate nonce and candidate encryption key.

In order to determine whether the encrypted file has been decrypted using the candidate nonce and candidate encryption key pair, the decryption analysis component may analyse at least a predetermined initial number of bytes of the encrypted file 605. The predetermined initial number of bytes may be any suitable number of bytes to determine whether the encrypted file may be successfully decrypted. The predetermined initial number of bytes may be 8 bytes, 16 bytes, 32 bytes, 64 bytes and so on. In this example, the predetermined initial number of bytes in 16 bytes. A predetermined initial number of bytes is used as irrespective of the file type, e.g. a file with or without a file header, a determination of a successful decryption can be made.

If the decryption analysis component identifies that the at least initial 16 bytes of the first potentially decrypted file is valid then the candidate nonce and candidate encryption key that were successful are stored 606, all encrypted files may be decrypted 607 and decryption process ends 608. However, if the file decryption analysis component identifies that the at least initial 16 bytes of the first potentially decrypted file is invalid 605 then the decryption analysis component checks if all possible candidate nonce and candidate encryption key pairs have been tested 603, if not then the process is repeated for a further candidate nonce and candidate encryption key pair.

Once all possible candidate nonce and candidate encryption key pairs have been tested with no valid decryption determined then the process ends 608. Thus, the decryption process iteratively repeats until a valid decryption is identified or all of the possible combinations of candidate nonce and candidate encryption key has been exhausted.

Once a valid decryption is identified the decryption analysis component may further store parameters relating to the memory location of the successful candidate nonce and the successful candidate encryption.

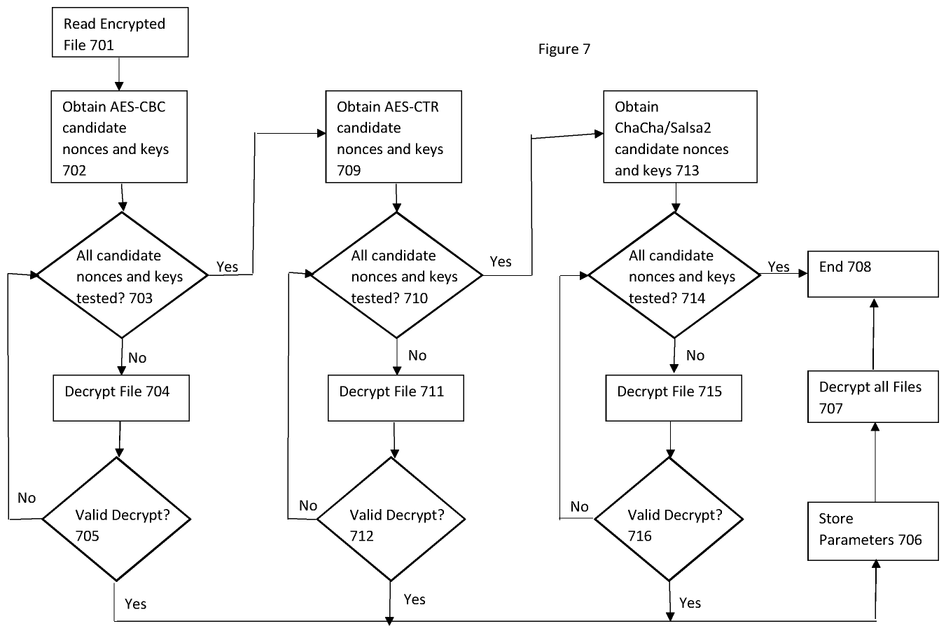

As one of several encryption algorithms may have been used in the ransomware attack then the decryption analysis component may alternatively or additionally iteratively cycle through different known encryption algorithms using all available combinations of the candidate nonces and candidate encryption keys relevant to the different encryption algorithms. This is shown in FIG. 7 where a first encryption algorithm is selected being the AES-CBC encryption algorithm, in the example of FIG. 7. The decryption analysis component first reads the encrypted file from memory 701 and obtains all candidate nonces and candidate encryption keys that correspond to the AES-CBC encryption algorithm 702. It is then determined if all of the candidate nonces and candidate encryption keys that correspond to the AES-CBC encryption algorithm have been tested 703. If not all of the candidate nonces and candidate encryption keys that correspond to the AES-CBC encryption algorithm have been tested then the decryption analysis component attempts to decrypt the encrypted file using a candidate nonce and candidate encryption key pair to generate a potential decrypted file 704. At least the initial 16 bytes of the potential decrypted file is analysed to determine if a valid decryption has occurred 705.

If a valid decryption is determined then the decryption analysis component stores parameters relating to at least one of the successful encryption algorithm, the successful candidate nonce, the successful candidate encryption key, the memory location of the candidate nonce and candidate encryption key 706. Based on the stored information the decryption analysis component can then proceed to decrypt all other files that have been encrypted, or are being encrypted, by the ransomware 707 and the process may end 708.

If an invalid decryption is determined 705 then it is determined if all candidate nonces and candidate encryption keys have been tested 703. If all candidate nonces and candidate encryption keys have not been tested a further candidate nonce and candidate encryption key pair is used to attempt decryption of the encrypted file to generate a further potential decrypted file 704. At least the initial 16 bytes of the potential decrypted file is analysed to determine if a valid decryption has occurred 705. If a valid decryption is determined then the relevant parameters are stored 706, all files are decrypted 707 and the process ends 708. If a valid decrypt is not determined then it checks if all candidate nonces and candidate encryption keys have been tested 703, and so on. This process is iteratively repeated until either a valid decryption is determined or all combination of suitable candidate nonce and candidate encryption key pairs have been tested for the first selected encryption algorithm, the AES-CBC encryption algorithm.

If no valid decryption is determined then the decryption analysis component selects a second encryption algorithm. In the example of FIG. 7, the second selected encryption algorithm is the known AES-CTR encryption algorithm. The process is repeated in that all possible candidate nonce and candidate encryption key are obtained 709 and it is determined if all of the candidate nonces and candidate encryption keys have been tested 710. If they have not all been tested then the encrypted file is attempted to be decrypted using a candidate nonce and candidate encryption key pair to generate a potential decrypted file 711. At least the initial 16 bytes of the potential decrypted file is analysed to determine if a valid decryption has occurred 712. If a valid decryption is determined then the relevant parameters are stored 706, all files are decrypted 707 and the process ends 708. If a valid decrypt is not determined then it checks if all candidate nonces and candidate encryption keys have been tested 710, and so on. This process is iteratively repeated until either a valid decryption is determined or all combination of suitable candidate nonce and candidate encryption key pairs have been tested for the second selected encryption algorithm, the AES-CTR encryption algorithm.

If no valid decryption is determined then the decryption analysis component selects a third encryption algorithm. In the example of FIG. 7, the third selected encryption algorithm are the known ChaCha20/Salsa20 encryption algorithms. The process is again repeated in that all possible candidate nonce and candidate encryption key are obtained 713 and it is determined if all of the candidate nonces and candidate encryption keys have been tested 714. If they have not all been tested then the encrypted file is attempted to be decrypted using a candidate nonce and candidate encryption key pair to generate a potential decrypted file 715. At least the initial 16 bytes of the potential decrypted file is analysed to determine if a valid decryption has occurred 716. If a valid decryption is determined then the relevant parameters are stored 706, all files are decrypted 707 and the process ends 708. If a valid decrypt is not determined then it checks if all candidate nonces and candidate encryption keys have been tested 714, and so on. This process is iteratively repeated until either a valid decryption is determined or all combination of suitable candidate nonce and candidate encryption key pairs have been tested for the third selected encryption algorithms, the ChaCha20/Salsa20 encryption algorithm.

If no valid decryption is determined then the decryption analysis process ends 708.

In the example of FIG. 7, three encryption algorithms are used to attempt to decrypt the encrypted file. However, as will be appreciated, any number of known encryption algorithms may be selected and used to attempt to identify a valid decryption of the encrypted file so that all encrypted files by the ransomware can be decrypted.

As described above in relation to FIGS. 6 and 7, a valid decryption is identified by analysing at least the initial 16 bytes of the potential decrypted file.

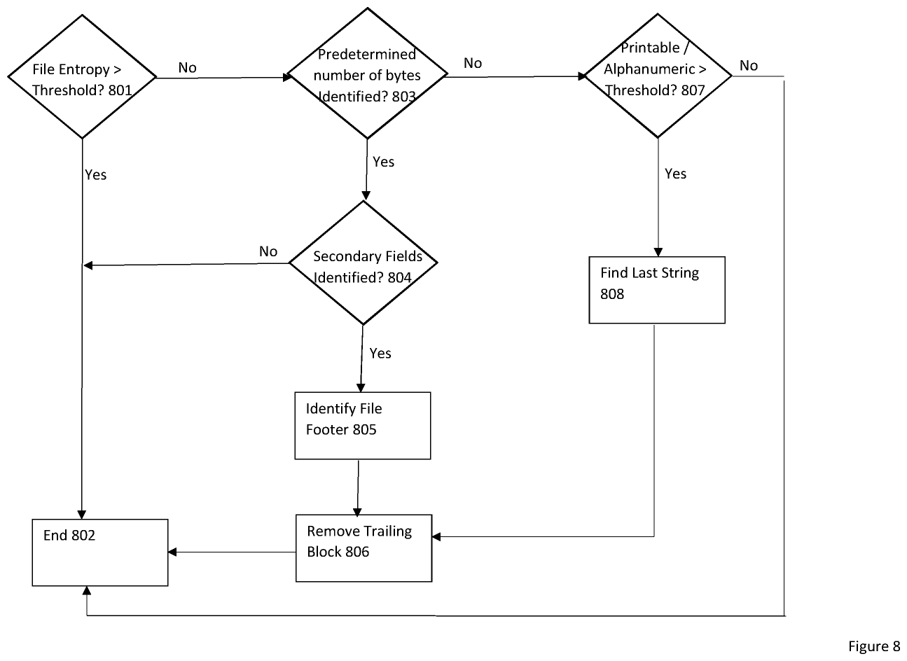

The validation and verification is shown in more detail in relation to FIG. 8. The entropy of the potentially decrypted file is determined, for example using the Shannon entropy or modified Shannon entropy and compared to a predetermined threshold 801. The predetermined threshold may be any suitable threshold for the method of determining the entropy value and may be based on related parameters such as the predetermined initial number of bytes being analysed. For example, using Shannon entropy the threshold may be 3.5 or using the modified Shannon entropy, with a predetermined power of 10⁷, the threshold may be 35000000. If the determined entropy is greater than the predetermined threshold then it is determined that an invalid decrypt has occurred and the verification and validation process ends 802.

If the determined entropy is not greater than the predetermined threshold then it is determined if the initial 16 bytes of the potentially decrypted file includes readable components that may be identifiable 803. The readable components may include, for example, components of a typical file header that relate to the file type, e.g. ‘JFIF’, ‘PDF’ or ‘MZ’ for JPEG File Interchange Format, Portable Document Format, and DOS MZ executable files respectively. If the readable components are identified it may then be determined if secondary fields can be identified 804, for example, ‘[Content_Types].xml’ in Microsoft Office files. Any suitable secondary fields may be used based on potential file types and by determining if secondary fields can be identified the risk of false positives may be reduced or prevented. If the secondary fields are identified then the file footer may further be identified 805 and any trailing data block subsequent to the file footer field can be removed 806. This indicates that a valid decrypt of the file has occurred and the verification and validation process ends 802. If the secondary fields are not identified then it is considered an invalid decrypt and the verification and validation process ends 802.

If readable components of a typical file header cannot be identified 803 in the predetermined initial number of bytes, the file may be a plaintext file which does not include a file header. In this case a valid decrypted file may also be determined by determining whether the proportion, or ratio, of printable characters and/or alphanumeric characters exceeds a predetermined threshold 807. Any suitable threshold may be predetermined based on the predetermined initial number of bytes analysed, for example, in relation to printable characters in the initial 16 bytes the threshold may be 15 and in relation to alphanumeric characters in the initial 16 bytes the threshold may be 10. If the proportion, or ratio, of printable characters and/or alphanumeric characters exceed the threshold the last printable character string in the plaintext file may be identified 808 and any trailing data block subsequent to the last printable character string in the plaintext file can be removed 806. This indicates that a valid decrypt of the file has occurred and the verification and validation process ends 802. If the proportion of printable characters and/or alphanumeric characters does not exceed the predetermined threshold then it is considered an invalid decrypt and the verification and validation process ends 802.

In the verification and validation process, a trailing block is removed from the decrypted file. This is because ransomware commonly appends a trailing data block after the encrypted file data containing, inter alia, the encryption key, encrypted with the ransomware public key so these must be removed for file recovery. The exact size of the trailing data block appended by the ransomware after decrypting the first file may further be determined by comparison with the decrypts of following ransomware encrypted files and/or based on the encryption algorithm used in the ransomware.

In the foregoing embodiments, features described in relation to one embodiment may be combined, in any manner, with features of a different embodiment in order to provide efficient and effective ransomware detection and recovery. Note that, the above description is for illustration only and other embodiments and variations may be envisaged without departing from the scope of the invention as defined by the appended claims.

1. A method of detecting a file encrypted by ransomware in a computing device, comprising:
identifying a file write operation for a file on the computing device; determining if a predetermined number of bytes of the file is stored in a memory buffer on the computing device;
determining an entropy value of the predetermined number of bytes in the memory buffer;
comparing the determined entropy value of the predetermined number of bytes to a first predetermined threshold; and
wherein if the determined entropy value exceeds the first predetermined threshold, flagging the file associated with the file write operation as potentially encrypted by ransomware.

2. The method according to claim 1, further comprising: monitoring an operation of the computing device to identify the file write operation.

3. The method according to claim 1, in which determining the entropy value is based on a Shannon entropy or a modified Shannon entropy.

4. The method according to claim 1, in which if the determined entropy value does not exceed the first predetermined threshold, the method further comprises: comparing the determined entropy value to a second predetermined threshold, wherein the second predetermined threshold is lower than the first predetermined threshold.

5. The method according to claim 4, in which if the determined entropy value exceeds the second predetermined threshold, the method further comprises: determining one or more parameters related to the predetermined number of bytes; comparing the determined one or more parameters to respective predetermined thresholds; and wherein if the determined one or more parameters do not exceed the respective predetermined threshold, flagging the file associated with the file write operation as potentially encrypted by ransomware.

6. The method according to claim 5, in which the one or more parameters include an ASCII frequency count and a maximum ASCII string length.

7. A computing device comprising:
a processor; and
a memory buffer;
wherein the processor is configured to:
identify a file write operation for a file on the computing device;
determine if a predetermined number of bytes of the file is stored in the memory buffer on the computing device; determine an entropy value of the predetermined number of bytes in the memory buffer;
compare the determined entropy value of the predetermined number of bytes to a first predetermined threshold; and
wherein if the determined entropy value exceeds the first predetermined threshold, the processor is further configured to flag the file associated with the file write operation as potentially encrypted by ransomware.

8. The computing device according to claim 7, in which the processor is further configured to: monitor an operation of the computing device to identify the file write operation.

9. The computing device according to claim 7, in which the processor is configured to determine the entropy value based on a Shannon entropy or a modified Shannon entropy.

10. The computing device according to claim 7, in which if the determined entropy value does not exceed the first predetermined threshold, the processor is further configured to: compare the determined entropy value to a second predetermined threshold, wherein the second predetermined threshold is lower than the first predetermined threshold.

11. The computing device according to claim 10, in which if the determined entropy value exceeds the second predetermined threshold, the processor is further configured to: determine one or more parameters related to the predetermined number of bytes; compare the determined one or more parameters to respective predetermined thresholds; and wherein if the determined one or more parameters do not exceed the respective predetermined threshold, the processor is further configured to flag the file associated with the file write operation as potentially encrypted by ransomware.

12. The computing device according to claim 11, in which the one or more parameters include an ASCII frequency count and a maximum ASCII string length.

13. A computer program product comprising computer readable executable code for implementing the method comprising:
identifying a file write operation for a file on the computing device;
determining if a predetermined number of bytes of the file is stored in a memory buffer on the computing device;
determining an entropy value of the predetermined number of bytes in the memory buffer;
comparing the determined entropy value of the predetermined number of bytes to a first predetermined threshold; and
wherein if the determined entropy value exceeds the first predetermined threshold, flagging the file associated with the file write operation as potentially encrypted by ransomware.
